(19) United States
(12) Patent Application Publication
(10) Pub. No.: US 2005/0251332 A1
(43) Pub. Date: Nov. 10, 2005

(54) Method for correlating altitude and/or grade information with route points of a digital map

(75) Inventors: Volker Entenmann, Affalterbach (DE); Stefan Enderle, Blaubeuren (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/085,670

(22) Filed: Mar. 21, 2005

(30) Foreign Application Priority Data
Mar. 22, 2004 (DE) 10 2004 014 322.6

(51) Int. Cl. G01C 21/26

(52) U.S. Cl. 701/208; 701/200

(57) ABSTRACT

A method for method for correlating altitude and/or grade information with route points of a digital map includes correlating geographic altitude information and/or grade information of a digital geographic map with route points of a digital map. Altitude data of a road is derived from the correlated geographic information. The correlated geographic information is corrected by smoothing the derived altitude data so as to approximate a course of a road to the correlated geographic information. The smoothing is performed as a function of at least one attribute of the road.

Priority is claimed to German patent application DE 102004014322.6, filed Mar. 22, 2004, the entire disclosure of which is hereby incorporated by reference herein.

The present invention relates to a method for correlating altitude and/or grade information with route points of a digital map.

### BACKGROUND

Document JP-2001-305953-A1 describes the correlation of altitude information of a geographic map with routes of a two-dimensional map. It is described there that the actual altitudes of the road types “tunnels” and “bridges” differ from the geographic altitudes of the corresponding points. The actual altitudes of the route points on roads of this type are then to be determined by interpolation from the start and end points of the roads of this type.

From U.S. Patent Application No. 2001/0005810-A1 it is known to combine information of a two-dimensional map including the courses of routes with a corresponding three-dimensional map in order to infer information about the altitude profile of the routes in question. Thus, here too, altitude information is correlated with information about the route.

### SUMMARY OF THE INVENTION

An object of the present invention is to improve the meaningfulness of altitude and/or grade information that is correlated with individual points of a route.

Apart from navigation, digital road maps are also increasingly used as a source of information for driver assistance systems. In conjunction with the vehicle positioning system, the digital road map makes it possible to generate a route preview, allowing information about specific route characteristics that are relevant for the driving task (such as narrow curves, changes in speed limit) to be provided to the driver at an early point in time, or allowing various vehicle systems, such as headlamp adjustment, open- and closed-loop control systems for automatic cruise control (ACC), to be pre-controlled or adapted in terms of their performance to the upcoming driving environment.

However, grade data in digital maps are of great use for predictive driving features, especially in a commercial vehicle for various features such as the shifting of the transmission, the operation of the cruise control, and the torque selection. In particular, in the case of heavily loaded commercial vehicles, already small changes in grade require the shifting of gears in the transmission. Since each gear change involves an interruption of the tractive force for several seconds, which results in a loss of speed, it is particularly important to select the optimum gear change points. However, customary automatic transmissions in commercial vehicles are controlled without any knowledge about the grade profile that is coming up next and are therefore not able to respond to changes in grade in a predictive manner. In certain cases, this leads to a wrong gear selection, which, in addition, results in increased fuel consumption.

This problem can be overcome by providing a map-based route preview that includes grade information as well.

In accordance with the present invention, a correction operation is performed, the correction being accomplished by approximating the course of a road, in terms of its altitude data, to the correlated geographic information by smoothing its altitude data derived from the correlated geographic information; the smoothing being carried out as a function of the attributes of the road.

Thus, there are different types of roads, including, for example, bridges or tunnels. In these types of roads, there is no direct, intrinsic correlation between the geographic altitude profile of the landscape and the altitude profile of the road of the type in question.

The attributes of the roads are to be distinguished from this. The purpose of the road attributes is to define whether the altitude profile of the road matches at least almost completely the profile of the landscape, or whether and to what degree earth is being moved during road construction in an appropriate way according to the attributes in order to avoid, or at least reduce, changes in the altitude profile of the road.

Exemplary attributes include the following:
road class,
speed limits,
average traffic load, in particular that caused by heavy truck traffic,
traffic load at peak times, in particular that caused by heavy truck traffic,
number of lanes in one direction of travel,
completion date,
national territory of the road in question.

The road class relates to the attribute of whether the road in question is an expressway, a national highway, a state road, or a country road. The degree to which the road in question is designed also for heavy truck traffic can be deduced from this accordingly. The fact of whether higher-class roads following at least approximately the same directional course exist in the vicinity may optionally be taken into account for this purpose. It is known from experience that national highways are constructed to a lower standard when there is an expressway running in parallel. However, if there is no parallel expressway, long-distance traffic is via the national highway, so that it may be expected that this national highway is constructed to an appropriate standard. In connection with the individual road classes, it is, of course, also possible to distinguish whether or not the national highway in question is important for long-distance traffic. The same applies here to other road classes. The greater the importance of the road for long-distance traffic, the greater the probability that earth was moved during the construction of the route in order to reduce differences in altitude. The more important the route, the higher the degree of smoothing that should be carried out in the present method.

A further attribute may be, for example, the existence of speed limits on the route. Apart from the criterion that an appropriate speed limit may be imposed for reasons of traffic safety when a certain traffic load is exceeded, such a speed limit may also be related to the conditions of the route. In addition to junctions and bends, these conditions may also include the grade of the route. Therefore, if a speed limit can be correlated with the grade of the route in a certain section, smoothing is conveniently performed only to a lesser degree because a certain grade has just been ascertained.

Other criteria may include, for example, the average traffic load, in particular that caused by heavy truck traffic, or also the traffic load at peak times, in particular that caused by heavy truck traffic. The more pronounced the traffic load, the greater the probability that the route in question was constructed to a higher standard. Then, stronger smoothing should be employed when carrying out the method of the present invention.

Another criterion may be the number of lanes in one direction of travel. Especially when in the case of a grade ascertained on the basis of the geographic altitude information, an additional uphill lane is detected, it may be inferred that the additional uphill lane is intended to facilitate passing. In this situation, a lower degree of smoothing may be used. If, on a section of a national highway, there are always several lanes in each direction, it may be inferred that the national highway is of importance for long-distance traffic and is therefore constructed to an appropriate standard. In this case, a correspondingly higher level of smoothing is then to be used for carrying out the method.

Another criterion may be the date of completion of the road in question. In accordance with the guidelines for the course of relevant roads, it may be that the guidelines have changed. Therefore, if a smoothing is performed under the aspect that a boundary condition for the resulting routing of the road is that it must comply with the guidelines, it is useful for this boundary condition to be based on the guidelines that were in force at the time when the road was planned and/or completed. It is obvious that, for this purpose, the date must not necessarily be indicated with an accuracy of one day.

A further criterion may be the national territory of the road in question. The guidelines and practices used in construction planning and execution for the routing of the roads in question may differ in the various countries. This may advantageously be taken into account.

In an embodiment, in addition, the road type is taken into account in that for the road types “tunnel” and/or “bridge” the information along this road type is correctively correlated as a function of the correlated geographic information at the start and end points of the road type in question; the correlated geographic information not being taken into account in this correction.

Unlike with the road attributes, where the assumed altitude profile of the road is approximated to the geographic altitude profile in accordance with certain criteria, in the case of these road types, the altitude profile is determined independently of the geographic altitudes along the route.

In an embodiment, the smoothing is carried out in such a manner that certain maximum values of the grade and/or of the change in grade of the roads are not exceeded. This advantageously allows predefined boundary conditions to be taken into account when carrying out the method.

In an embodiment, the smoothing is carried out in such a manner that certain maximum values of the grade and/or of the change in grade of the roads are not exceeded, depending on the particular road attributes.

In comparison with the previously described embodiment, it turns out to be advantageous here that the boundary conditions may be taken into account in a better-adapted form.

### BRIEF DESCRIPTION OF THE DRAWINGS

An exemplary embodiment of the present invention is described below and illustrated in the drawings.

FIG. 1 shows an example of a contour line pattern in a grid representation.

FIG. 2 is a representation of a functional block diagram.

### DETAILED DESCRIPTION

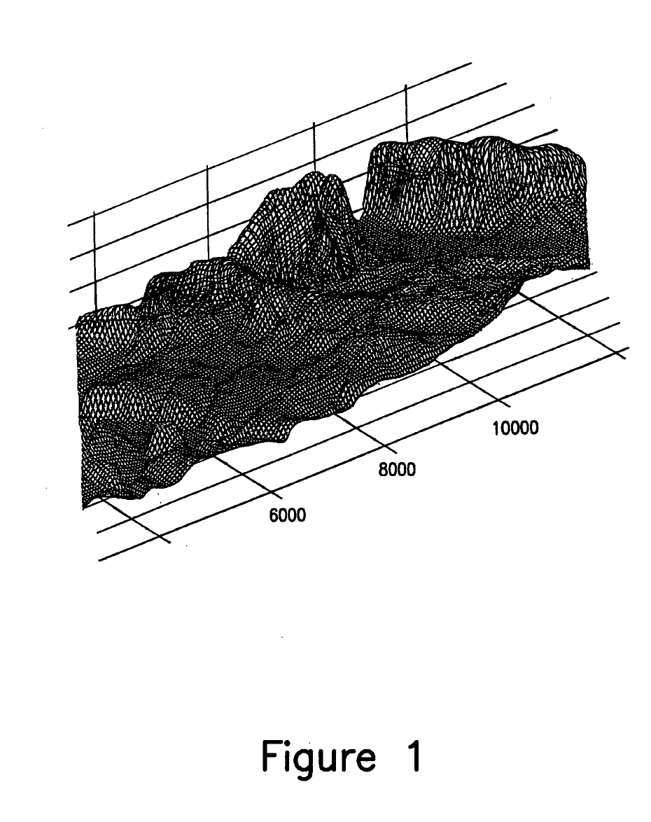

Using the method described herein, grade data can be obtained from digital terrain models in an inexpensive manner on an area-wide basis. Digital terrain models (DTM) describe the surface of the earth by a three-dimensional grid of equidistant grid points, as shown, for example, in FIG. 1. Each grid point contains altitude information. During the Shuttle Radar Topography Mission (SRTM) in the year 2000, NASA recorded, for example, altitude information from which a nearly worldwide DTM having a grid point spacing of 30 m and an absolute altitude accuracy of 16 m was generated. This DTM altitude data is available, for example, for the method described herein.

The German Guideline for Road Construction (RAS) stipulates, at least for the Federal Republic of Germany, the requirement that the routing of a road in terms of altitude should be such that it is adapted to the natural terrain to the best extent possible. Since the natural terrain is represented by the DTM, the altitude profile of the road can be determined by blending the (two-dimensional) digital map with the (three-dimensional) DTM, and the grade profile can be determined in a further processing step.

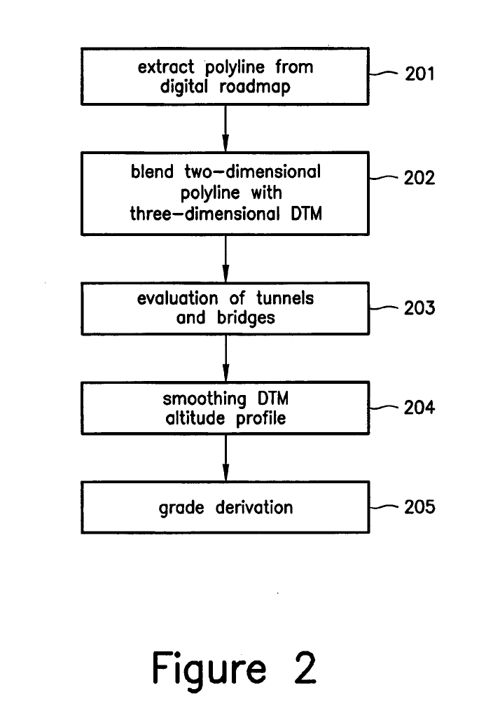

FIG. 2 shows a flow chart of the method. In a first step 201, a polyline describing the (two-dimensional) geometry of the road is extracted from the digital road map. In this connection, the position of each polygon point is defined by a longitude coordinate and a latitude coordinate. Additional information (attributes) about each polygon segment may also be obtained from the digital map. This includes, for example, the road class (expressway, national highway, etc.). Other attributes, such as those described above, may be obtained. Also obtainable is the road type, which indicates, in particular, whether the segment in question is a tunnel or a bridge. This additional information turns out to be very helpful for carrying out the method of the present invention.

For example, as explained earlier, the road class is indicative of the extent to which a road matches the natural terrain and of the rate at which the grade may change along the road.

For example, expressways and national highways are designed for high traveling speeds and heavy trucks. Therefore, normally, a separate route is constructed for these roads in order to avoid, to the extent possible, heavy grades and changes in grade. In contrast, small state and country roads do not have a separate route throughout and are therefore more likely to directly follow the terrain. Consequently, heavy grades and sudden changes in grade may occur on these routes.

Bridges and tunnels are in turn route sections on which there are naturally greater differences in altitude between the natural terrain and the road.

Then, in a following step 202, the two-dimensional polyline is blended with the three-dimensional DTM. To this end, preferably equidistant intermediate points are determined along the polyline. For each of these intermediate points, the surrounding grid points of the DTM are selected based on its coordinates. The DTM altitude at the intermediate point in question is determined from the altitude values of these grid points using a suitable method (such as averaging or interpolation).

This results in the DTM altitude profile along the polyline.

Then, in a following step 203, the evaluation of tunnels and bridges is carried out. In the area of bridges and tunnels, as explained earlier, there are, naturally, differences between the altitude of the natural terrain and that of the road. In order to correct the DTM altitude profile accordingly, the start and end points of bridges and tunnels are determined from the attributes of the polygon segments, and new altitude values are determined for the segments located therebetween by linear interpolation between the altitudes at the respective start and end points.

In a further step 204, the DTM altitude profile is smoothed. This takes into account the fact that the altitude profile of a road can be differentiated continuously and twice throughout, i.e., that there are no sudden changes in the altitude value or grade. The smoothing of the altitude profile also allows calculation of the grade by differentiation.

Smoothing can be accomplished using various methods, such as classical low-pass filters or smoothing splines. In any case, the smoothing parameter used may be adapted to the road class or also to other attributes to obtain optimum results. As explained earlier, expressways normally do not exhibit any abrupt changes in grade because of their specific routing. Therefore, the DTM altitude data may be strongly smoothed for this road class. In contrast, small country roads follow the natural terrain much more directly, so that the smoothing parameter should be set here to allow greater dynamics in the altitude profile.

Compared to a smoothing of the DTM altitude data without taking the attributes into account in accordance with the present invention, the present invention provides the advantage of being able to take into account that there are no extreme grades, which, according to the German Guideline for Road Construction (RAS), are not permissible for real roads.

It has turned out to be advantageous to proceed in such a manner when carrying out the method that the altitude profile of the road is described by the design elements specified in the Guideline for Road Construction for the grade map:
straight lines for route sections having a constant grade; and
parabolas for crests and troughs.

In this procedure, first the apex positions of crests and troughs and the corresponding radii of curvature are estimated from the DTM altitude data. Then, using a nonlinear optimization method, the parameters of the grade map, that is, the number, positions and radii of curvature of the parabolas, are improved until an objective function reaches its minimum.

Various criteria are taken into account in this objective function:
the difference in altitude between the DTM and the grade map,
the occurring grades, and
the occurring curvatures.

The objective function to be minimized allows the boundary conditions specified in the Guideline for Road Construction for grades and curvatures to be complied with by “penalizing” deviations from the permissible range of values with high function values. The grade map constructed from parabolas and straight lines has the further advantage that its grade profile can be represented by a small number of interpolation points between which the grade changes linearly. As a result of this, the map enhanced with grade data requires a small amount of memory, and the grade information can be easily processed further.

Finally, in a last processing step 205, the grades are derived from the smoothed altitude data by differentiation.

The grade data may be stored in the digital map in different ways. For example, the entire grade profile may be represented by a series of polynomials having the same or different degrees. A polynomial of degree 0 means that the grade is constant on some sections. A polynomial of degree 1 means that the grade changes linearly within a section of the route. This is the case, for example, when crests and troughs are represented by the parabolas mentioned herein above. Higher-degree polynomials can be used to describe the grade profile of larger route sections by a single polynomial and to thereby save memory space.

However, for some driving features, it may be sufficient if only certain characteristic points in the grade profile are marked in the digital map. Such points may be, for example, the apices of the crests and troughs or points of abrupt change in grade.

1. A method for correlating altitude and/or grade information with route points of a digital map, the method comprising:
correlating geographic altitude information and/or grade information of a digital geographic map with route points of a digital map;
deriving, from the correlated geographic information, altitude data of a road of the route points; and
correcting the correlated geographic information by smoothing the derived altitude data so as to approximate a course of a road to the correlated geographic information, the smoothing being performed as a function of at least one attribute of the road.

2. The method as recited in claim 1 wherein the at least one attribute includes at least one of a road class, a speed limit, an average traffic load, a traffic load at a peak time, a number of lanes in a direction of travel, a completion date and a national territory of the road.

3. The method as recited in claim 2 wherein at least one of the average traffic load and the traffic load at a peak time is a traffic load caused by heavy truck traffic.

4. The method as recited in claim 1 further comprising correctively correlating, for a tunnel and/or bridge road type, respective altitude data of the derived altitude data as a function of the correlated geographic information at a start and at an end point of the tunnel and/or bridge.

5. The method as recited in claim 2 further comprising correctively correlating, for a tunnel and/or bridge road type, the respective derived altitude information as a function of the correlated geographic information at a start and at an end point of the tunnel and/or bridge.

6. The method as recited in claim 1 wherein the smoothing is performed so as not to exceed at least one defined maximum value of the grade and/or of the change in grade of the road.

7. The method as recited in claim 2 wherein the smoothing is performed so as not to exceed at least one defined maximum value of the grade and/or of the change in grade of the road.

8. The method as recited in claim 4 wherein the smoothing is performed so as not to exceed at least one defined maximum value of the grade and/or of the change in grade of the road.

9. The method as recited in claim 5 wherein the smoothing is performed so as not to exceed at least one defined maximum value of the grade and/or of the change in grade of the road.

10. The method as recited in claim 1 wherein the smoothing is performed so as not to exceed at least one defined maximum value of the grade and/or of the change in grade of the road, the at least one defined maximum value being a function of the at least one road attribute.

11. The method as recited in claim 2 wherein the smoothing is performed so as not to exceed at least one defined maximum value of the grade and/or of the change in grade of the road, the at least one defined maximum value being a function of the at least one road attribute.

12. The method as recited in claim 4 wherein the smoothing is performed so as not to exceed at least one defined maximum value of the grade and/or of the change in grade of the road, the at least one defined maximum value being a function of the at least one road attribute.

13. The method as recited in claim 5 wherein the smoothing is performed so as not to exceed at least one defined maximum value of the grade and/or of the change in grade of the road, the at least one defined maximum value being a function of the at least one road attribute.
